(19) United States
(12) Patent Application Publication
(10) Pub. No.: US 2002/0143125 A1
(43) Pub. Date: Oct. 3, 2002

(54) Catalyst component and catalyst system having a high polymerization activity for preparing polymers

(76) Inventors: Walter Kaminsky, Pinneberg (DE); Stephan Lenk, Hamburg (DE); Volker Scholz, Hamburg (DE); Herbert Roesky, Gottingen (DE); Axel Herzog, Los Angeles, CA (US)

Correspondence Address: Herbert B. Keil, KEIL & WEINKAUF, 1101 Connecticut Avenue, N.W., Washington, DC, 20036, US

(21) Appl. No.: 10/033,606

(22) Filed: Jan. 2, 2002

Related U.S. Application Data
(62) Division of application No. 09/068,736, filed on May 3, 1999.

(30) Foreign Application Priority Data
Aug. 18, 1995 (DE) 19530406.3

(51) Int. Cl. C08F 4/44

(52) U.S. Cl. 526/160; 526/346; 526/943; 502/152

(57) ABSTRACT

Catalyst systems having a high polymerization activity comprise at least one catalyst component of the formula (I):

RₙMXₘ (I),

where M¹=Ti, Zr or Hf, R^{a}=C₅ (R¹, R², R³, R⁴, R⁵) or C₆ (R¹, R², R³, R⁴, R⁵, R⁶), where R¹, R², R³, R⁴, R⁵ and R⁶ are identical or different and are each a hydrogen atom, a C₁-C₂₀-alkyl group, a C₁-C₁₀-alkoxy group, a C₁-C₁₀-fluoroalkyl group, a C₆-C₂₀-aryl group, a C₆-C₁₀-aryloxy group, a C₂-C₁₀-alkenyl group, a C₆-C₁₀-fluoroaryl group, a C₇-C₄₀-arylalkyl group, a C₇-C₄₀-alkylaryl group, a C₈-C₄₀-arylalkenyl group, a silyl group or a germyl group or adjacent radicals R¹, R², R³, R⁴, R⁵ and R⁶ together with the atoms connecting them form a ring system, R^{b}=a fluorine atom when m=1, at least one fluorine atom when m>1 and can be identical or different and be at least one hydrogen atom, a C₁-C₂₀-alkyl group, a C₁-C₁₀-alkoxy group, a C₁-C₁₀-fluoroalkyl group, a C₆-C₂₀-aryl group, a C₆-C₁₀-aryloxy group, a C₂-C₁₀-alkenyl group, a C₆-C₁₀-fluoroaryl group, a C₇-C₄₀-arylalkyl group, a C₇-C₄₀-alkylaryl group, a C₈-C₄₀-arylalkenyl group, an OH group, an NR⁷₂ or SR⁸₁ group, where R⁷ and R⁸ are each a C₁-C₂₀-alkyl group, a C₁-C₁₀-alkoxy group, a C₁-C₁₀-fluoroalkyl group, a C₆-C₂₀-aryl group, a C₆-C₁₀-aryloxy group, a C₂-C₁₀-alkenyl group, a C₆-C₁₀-fluoroaryl group, a C₇-C₄₀-arylalkyl group, a C₇-C₄₀-alkylaryl group or a C₈-C₄₀-arylalkenyl group, a silyl group, a germyl group or a halogen atom, m and n are integers, m+n=2-4 and m is at least 1.

The present invention relates to catalyst components and catalyst systems having a high polymerization activity for preparing polymers which have a high melting point. The present invention also relates to an economical and environmentally friendly process for preparing polymers having a high melting point.

DE-A-4332009 discloses a process for preparing organometallic fluorides. Here, organometallic fluorides containing a π system are obtained by reacting a fluorine-free organometallic halide with a tin fluoride of the formula R₃SnF, where R are identical or different and are C₁-C₁₀-alkyl, C₆-C₁₄-aryl, C₂-C₁₀-alkenyl, C₇-C₂₀-arylalkyl or C₇-C₁₅-alkylaryl.

EP-A-210 615 discloses catalysts for the polymerization of styrene and processes for the polymerization of monostyrene to syndiotactic polystyrene.

It is known from Macromolecules 21 (1988), 3356 that titanium compounds containing a cyclopentadienyl ring have a particularly high polymerization activity. The styrene polymers obtained using these compounds as catalysts have comparatively low melting points.

It is an object of the present invention to provide a catalyst component and a catalyst system which has a high polymerization activity and gives polymers having high melting points. A further object of the present invention is to provide an economical and environmentally friendly polymerization process.

We have found that this object is achieved by a catalyst component for the polymerization of olefins, which comprises at least one compound of the formula (I):

R^{a}ₙM¹R^{b}ₘ (I),

where

M¹=Ti, Zr or Hf,

R^{a}=C₅ (R¹, R², R³, R⁴, R⁵) or C₆ (R¹, R², R³, R⁴, R⁵, R⁶), where R¹, R², R³, R⁴, R⁵ and R⁶ are identical or different and are each a hydrogen atom, a C₁-C₂₀-alkyl group, a C₁-C₁₀-alkoxy group, a C₁-C₁₀-fluoroalkyl group, a C₆-C₂₀-aryl group, a C₆-C₁₀-aryloxy group, a C₂-C₁₀-alkenyl group, a C₆-C₁₀-fluoroaryl group, a C₇-C₄₀-arylalkyl group, a C₇-C₄₀-alkylaryl group, a C₈-C₄₀-arylalkenyl group, a silyl group or a germyl group or adjacent radicals R¹, R², R³, R⁴, R⁵ and R⁶ together with the atoms connecting them form a ring system,

R^{b}=a fluorine atom when m=1, at least one fluorine atom when m>1 and can be identical or different and can be at least one hydrogen atom, a C₁-C₂₀-alkyl group, a C₁-C₁₀-alkoxy group, a C₁-C₁₀-fluoroalkyl group, a C₆-C₂₀-aryl group, a C₆-C₁₀-aryloxy group, a C₂-C₁₀-alkenyl group, a C₆-C₁₀-fluoroaryl group, a C₇-C₄₀-arylalkyl group, a C₇-C₄₀-alkylaryl group, a C₈-C₄₀-arylalkenyl group, an OH group, an NR⁷₂ or SR⁸₁ group, where R⁷ and R⁸ are each a C₁-C₂₀-alkyl group, a C₁-C₁₀-alkoxy group, a C₁-C₁₀-fluoroalkyl group, a C₆-C₂₀-aryl group, a C₆-C₁₀-aryloxy group, a C₂-C₁₀-alkenyl group, a C₆-C₁₀-fluoroaryl group, a C₇-C₄₀-arylalkyl group, a C₇-C₄₀-alkylaryl group, a C₈-C₄₀-arylalkenyl group, a silyl group, a germyl group or a halogen atom, an —OC(O)F group, an —OC(O)CR^{c}₃ group, an —OC(O)C₅R^{d}₄ group or an —OC(O)C₆R^{e}₅ group, where R^{c}, R^{d} and R^{e} are at least one fluorine atom and R^{c}, R^{d} and R^{e} can be identical or different and can be at least one hydrogen atom, a C₁-C₂₀-alkyl group, a C₁-C₁₀-alkoxy group, a C₁-C₁₀-fluoroalkyl group, a C₆-C₂₀-aryl group, a C₆-C₁₀-aryloxy group, a C₂-C₁₀-alkenyl group, a C₆-C₁₀-fluoroaryl group, a C₇-C₄₀-arylalkyl group, a C₇-C₄₀-alkylaryl group, a C₈-C₄₀-arylalkenyl group, an OH group, an NR⁷₂ or SR⁸ group, a silyl group, a germyl group or a halogen atom,

m and n are integers, m+n=2-4 and m is at least 1.

The present invention has the advantage that these catalyst components give catalyst systems having a high polymerization activity. The polymerization activity of the catalysts of the invention is calculated as the mass of polymer produced, based on the molar amount of the compound of group IV of the Periodic Table and based on the polymerization time. The particular advantage of the present invention is that polymers having high melting points are obtained using catalyst systems having a high polymerization activity. The increase in the polymerization activity in the case of previously known catalyst systems was hitherto associated with the disadvantage that the melting points of the polymers obtained always decreased. The high polymerization activity of the catalyst systems enables a polymerization to be carried out with very good results using smaller amounts of catalyst systems. This makes the polymerization process very economical and environmentally friendly.

Preference is given to catalysts of the present invention which have a cyclopentadienyl ring as ligand and 3 fluorine atoms bound directly to the metal atom M¹. Catalyst systems comprising these catalyst components display a good polymerization activity.

Particular preference is given to catalysts of the present invention which have a pentamethylated cyclopentadienyl ring as ligand and 3 fluorine atoms on the metal atom M¹. Catalyst systems comprising these catalyst components display a very good polymerization activity.

Particular preference is given to titanium as transition metal atom. Titanium as transition metal gives predominantly good polymerization activities.

The present invention provides a catalyst component comprising at least one bridge R⁹ between at least two radicals R^{a}. R⁹ is preferably

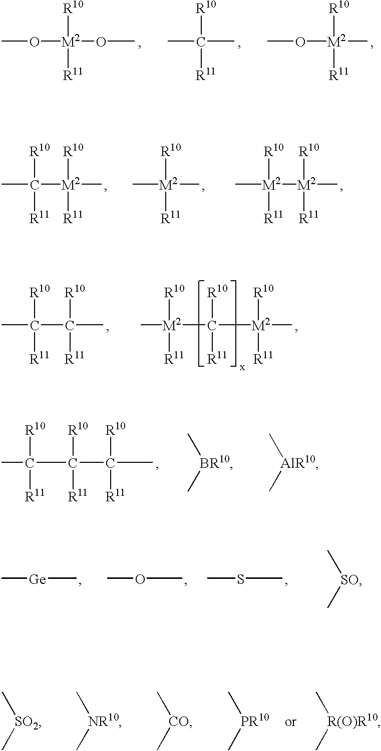

where R¹⁰ and R¹¹ are identical or different and are each a hydrogen atom, a halogen atom or a C₁-C₄₀-group such as a C₁-C₂₀-alkyl group, a C₁-C₁₀-fluoroalkyl group, a C₁-C₁₀-alkoxy group, a C₆-C₁₄-aryl group, a C₆-C₁₀-fluoroaryl group, a C₆-C₁₀-aryloxy group, a C₂-C₁₀-alkenyl group, a C₇-C₄₀-arylalkyl group, a C₇-C₄₀-alkylaryl group or a C₈-C₄₀-arylalkenyl group or R¹⁰ and R¹¹, in each case together with the atoms connecting them, form one or more rings, and x is an integer from zero to 18, M² is silicon, germanium or tin. R⁹ can also link two units of the formula (I) to one another.

The following examples illustrate the organometallic fluorides described by the formula I, but make no claim to completeness:

ethylenebis(indenyl)zirconium difluoride

ethylenebis(4,5,6,7-tetrahydroindenyl)zirconium difluoride

ethylenebis(2-methylindenyl)zirconium difluoride

ethylenebis(2,4-dimethylindenyl)zirconium difluoride

dimethylsilanediylbis(2-methyl-4,5-benzoindenyl)zirconium difluoride

dimethylsilanediylbis(2-methyl-4,6-diisopropylindenyl)zirconium difluoride

dimethylsilanediylbis(2-methyl-4-phenylindenyl)zirconium difluoride

dimethylsilanediylbis(2-ethyl-4-phenylindenyl)zirconium difluoride

dimethylsilanediylbis(2-methyl-4-(1-naphthyl)indenyl)zirconium difluoride

dimethylsilanediylbis(indenyl)zirconium difluoride

dimethylsilanediylbis(2-methyl-4-ethylindenyl)zirconium difluoride

dimethylsilanediylbis(2-methyl-4-isopropylindenyl)zirconium difluoride

dimethylsilanediylbis(2-methyl-4-methylindenyl)zirconium difluoride

dimethylsilanediylbis(2-ethyl-4-methylindenyl)zirconium difluoride

dimethylsilanediylbis(2-methyl-α-acenaphth-1-indenyl)zirconium difluoride

phenylmethylsilanediylbis(2-methyl-4-phenylindenyl)zirconium difluoride

phenylmethylsilanediylbis(2-methylindenyl)zirconium difluoride

ethylenebis(2-methyl-4,5-benzoindenyl)zirconium difluoride

ethylenebis(2-methyl-4,6-diisopropylindenyl)zirconium difluoride

ethylenebis(2-methyl-4-phenylindenyl)zirconium difluoride

ethylenebis(2-ethyl-4-phenylindenyl)zirconium difluoride

ethylenebis(2-methyl-4-(1-naphthyl)indenyl)zirconium difluoride

ethylenebis(indenyl)zirconium difluoride

ethylenebis(2-methyl-4-ethylindenyl)zirconium difluoride

ethylenebis(2-methyl-4-isopropylindenyl)zirconium difluoride

ethylenebis(2-methyl-4-methylindenyl)zirconium difluoride

ethylenebis(2-ethyl-4-methylindenyl)zirconium difluoride

ethylenebis(2-methyl-α-acenaphth-1-indenyl)zirconium difluoride

bis(2-methyl-4,5-benzoindenyl)zirconium difluoride

bis(2-methyl-4,6-diisopropylindenyl)zirconium difluoride

bis(2-methyl-4-phenylindenyl)zirconium difluoride

bis(2-ethyl-4-phenylindenyl)zirconium difluoride

bis(2-methyl-4-(1-naphthyl)indenyl)zirconium difluoride

bis(indenyl)zirconium difluoride

bis(2-methyl-4-ethylindenyl)zirconium difluoride

bis(2-methyl-4-isopropylindenyl)zirconium difluoride

bis(2-methyl-4-methylindenyl)zirconium difluoride

bis(2-ethyl-4-methylindenyl)zirconium difluoride

bis(2-methyl-α-acenaphth-1-indenyl)zirconium difluoride

bis(n-butylcyclopentadienyl)zirconium difluoride

bis(cyclopentadienyl)zirconium difluoride

bis(pentamethylcyclopentadienyl)zirconium difluoride

cyclopentadienylzirconium trifluoride

pentamethylcyclopentadienylzirconium trifluoride

(2-methyl-4,5-benzoindenyl)zirconium trifluoride

(2-methyl-4,6-diisopropylindenyl)zirconium trifluoride

(2-methyl-4-phenylindenyl)zirconium trifluoride

(2-ethyl-4-phenylindenyl)zirconium trifluoride

(2-methyl-4-(1-naphthyl)indenyl)zirconium trifluoride

indenylzirconium trifluoride

(2-methyl-4-ethylindenyl)zirconium trifluoride

(2-methyl-4-isopropylindenyl)zirconium trifluoride

(2-methyl-4-methylindenyl)zirconium trifluoride

(2-ethyl-4-methylindenyl)zirconium trifluoride

(2-methyl-α-acenaphth-1-indenyl)zirconium trifluoride

(n-butylcyclopentadienyl)zirconium trifluoride

isopropylidene(9-fluorenyl)cyclopentadienylzirconium difluoride

diphenylmethylene(9-fluorenyl)cyclopentadienylzirconium difluoride

phenylmethylmethylene(9-fluorenyl)cyclopentadienylzirconium difluoride

dimethylsilanediyl(9-fluorenyl)cyclopentadienylzirconium difluoride

isopropylidene(9-fluorenyl)(3-methylcyclopentadienyl)zirconium difluoride

diphenylmethylene(9-fluorenyl)(3-methylcyclopentadienyl)zirconium difluoride

phenylmethylmethylene(9-fluorenyl)(3-methylcyclopentadienyl)zirconium difluoride

dimethylsilanediyl(9-fluorenyl)(3-methylcyclopentadienyl)zirconium difluoride

isopropylidene(9-fluorenyl)(3-isopropylcyclopentadienyl)zirconium difluoride

diphenylmethylene(9-fluorenyl)(3-isopropylcyclopentadienyl)zirconium difluoride

phenylmethylmethylene(9-fluorenyl)(3-isopropylcyclopentadienyl)zirconium difluoride

dimethylsilanediyl(9-fluorenyl)(3-isopropylcyclopentadienyl)zirconium difluoride

isopropylidene(2,7-ditert-butyl-9-fluorenyl)cyclopentadienylzirconium difluoride

diphenylmethylene(2,7-ditert-butyl-9-fluorenyl)cyclopentadienylzirconium difluoride

phenylmethylmethylene(2,7-ditert-butyl-9-fluorenyl)cyclopentadienylzirconium difluoride

dimethylsilanediyl(2,7-ditert-butyl-9-fluorenyl)cyclopentadienylzirconium difluoride

ethylenebis(indenyl)titanium difluoride

ethylenebis(4,5,6,7-tetrahydroindenyl)titanium difluoride

ethylenebis(2-methylindenyl)titanium difluoride

dimethylsilanediylbis(indenyl)titanium difluoride

bis(indenyl)titanium difluoride

bis(cyclopentadienyl)titanium difluoride

bis(pentamethylcyclopentadienyl)titanium difluoride

cyclopentadienyltitanium trifluoride

pentamethylcyclopentadienyltitanium trifluoride

indenyltitanium trifluoride

(n-butylcyclopentadienyl)titanium trifluoride

isopropylidene(9-fluorenyl)cyclopentadienyltitanium difluoride

ethylenebis(indenyl)hafnium difluoride

ethylenebis(4,5,6,7-tetrahydroindenyl)hafnium difluoride

ethylenebis(2-methylindenyl)hafnium difluoride

dimethylsilanediylbis(indenyl)hafnium difluoride

bis(indenyl)hafnium difluoride

bis(cyclopentadienyl)hafnium difluoride

bis(pentamethylcyclopentadienyl)hafnium difluoride

cyclopentadienylhafnium trifluoride

pentamethylcyclopentadienylhafnium trifluoride

indenylhafnium trifluoride

(n-butylcyclopentadienyl)hafnium trifluoride

isopropylidene(9-fluorenyl)cyclopentadienylhafnium difluoride

bis(cyclopentadienyltitanium)fluoride

bis(methylcyclopentadienyltitanium fluoride)

bis(pentamethylcyclopentadienyltitanium)fluoride

[(Me₃SiC₅H₄)Ti(F)Nt—Bu]₂

The organometallic halides required as starting compounds are commercially available or can be prepared by methods known from the literature. The tin fluorides required as starting materials can be prepared by methods known from the literature (Ber. Dtsch. Chem. Ges. (1918), vol. 51, 1447).

The present invention provides a catalyst system comprising at least one catalyst component and at least one organic boron compound and/or at least one organic aluminum compound and/or at least one organic tin compound as cocatalyst. The catalyst system is obtainable by bringing at least one catalyst component into contact with at least one organic boron compound and/or at least one organic aluminum compound and/or at least one organic tin compound. This forms, in particular, the reaction product of at least one catalyst component and at least one organic boron compound and/or organic aluminum compound and/or organic tin compound and also reaction products of these compounds with condensation agents such as water. Very good polymerization activities are obtained using these catalyst systems. The cocatalyst component which, according to the present invention, may be present in the catalyst system comprises at least one compound of the aluminoxane, Lewis acid or ionic type which is converted into a cationic compound by reaction with a catalyst component.

As aluminoxane, preferance is given to using a compound of the formula II

(R AlO)ₙ (II).

Aluminoxanes can be, for example, cyclic as in formula III

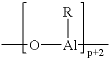

or linear as in formula IV

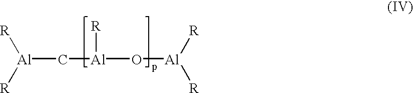

or of the cluster type as in formula V, as described in more recent literature; cf. JACS 117 (1995), 6465-74, Organometallics 13 (1994), 2957-2969.

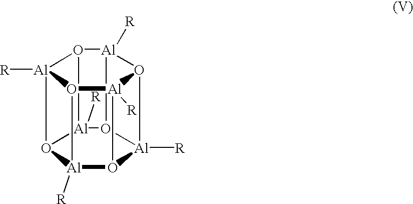

The radicals R in the formulae (II), (III), (IV) and (V) can be identical or different and be a C₁-C₂₀-hydrocarbon group such as a C₁-C₆-alkyl group, a C₆-C₁₈-aryl group, benzyl or hydrogen, and p is an integer from 2 to 50, preferably from 10 to 35.

The organic radicals are preferably identical and are methyl, isobutyl, n-butyl, phenyl or benzyl, particularly preferably methyl. If the organic radicals are different, they are preferably methyl and hydrogen, methyl and isobutyl or methyl and n-butyl, with hydrogen, isobutyl or n-butyl being present. As Lewis acid, preference is given to using at least one organoboron or organoaluminum compound which contains C₁-C₂₀-groups such as branched or unbranched alkyl or haloalkyl groups.

The present invention provides a catalyst system which may further comprise a support. The support component of the catalysts system of the present invention is preferably at least one inorganic oxide such as SiO₂, Al₂O₃, MgO, ZrO₂, TiO₂, B₂O₃, CaO, ZnO, ThO₂, carbonates such as Na₂CO₃, K₂CO₃, CaCO₃, MgCO₃, sulfates such as Na₂SO₄, Al₂(SO₄)₃, BaSO₄, nitrates such as KNO₃, Mg(NO₃)₂, Al(NO₃)₃ and also oxides such as Na₂O, K₂O and Li₂O. Supports employed are, in particular, silica and/or alumina and/or polymer supports. The present invention provides polymers and/or copolymers obtainable by polymerization using a catalyst system according to the present invention. Polymers and/or copolymers of 1-alkenes and vinylaromatics obtainable by polymerization using a catalyst system according to the present invention are particularly preferred. Syndiotactic polymers obtainable by polymerization using a catalyst system according to the present invention are very particularly preferred. Syndiotactic polystyrene obtainable by polymerization using a catalyst system according to the present invention is most preferred.

To polymerize preferably vinylaromatic monomers by the method according to the present invention, fluorine-containing transition metal compounds as catalyst component, organic boron compounds and/or organic aluminum compounds and/or organic tin compounds and reaction products of these with condensation agents, e.g. water, as cocatalyst component and also vinylaromatic monomer are used in any order. It is possible to use one or more supports. One or more solvents can be added thereto in any order. The introduction of the components and the reaction are carried out at atmospheric pressure or under subatmospheric or superatmospheric pressure in an inert gas atmosphere, e.g. nitrogen, argon or a mixture thereof. The reaction is preferably carried out in the temperature range of from 10 to 70° C. The constituents of the catalyst system are used in any molar ratio to one another. Preference is given to a ratio of aluminum to titanium of 100:1000.

The invention provides for the use of a catalyst system for preparing a polymer and/or copolymer, particularly for the polymerization and/or copolymerization of 1-alkenes and vinylaromatics, very particularly for the polymerization of styrene.

The invention is illustrated by the examples.

### EXAMPLES

### Example 1

A 100 ml glass reactor heated to 50° C. was charged in a counter-current of argon while stirring with, in succession, 14.1 ml of toluene, 5 ml of a methylaluminoxane solution in toluene (7.5×10⁻⁴ mol/5 ml), 20 ml of styrene and 0.9 ml of a toluene solution of cyclopentadienyltitanium trifluoride (2.5×10⁻⁶ mol/0.9 ml). The addition of the titanium compound was taken as the starting point of the polymerization. After 10 minutes, about 50 ml of a mixture of hydrochloric acid and ethanol were added. Stirring was continued for a further 12 hours. The solid product was filtered off and washed with ethanol until neutral. The polymer was dried under reduced pressure at room temperature.

### Comparative Example 1

Comparative Example 1 was carried out as described in Example 1, but using CpTiCl₃ as catalyst.

### Example 2

Example 2 was carried out as described in Example 1, but using Cp*TiF₃ as catalyst.

### Comparative Example 2

Comparative Example 2 was carried out as described in Example 1, but using Cp*TiCl₃ as catalyst.

Table 1 below shows the polymerization activities of the catalysts used in Example 1 and Comparative Example 1 and the characteristic data of the polymers obtained in Example 1 and Comparative Example 1.

TABLE 1

| | Comparative Example 1 | | | | Example 1 | | | |
|---|---|---|---|---|---|---|---|---|
| | CpTiCl₃^{a)} | | | | CpTiF₃^{a)} | | | |
| T(°C.)^{b)} | 10 | 30 | 50 | 70 | 10 | 30 | 50 | 70 |
| t(h)^{c)} | 0.22 | 0.08 | 0.12 | 0.25 | 0.52 | 0.14 | 0.17 | 0.43 |
| [Ti]^{j)} | 6.25 | 6.25 | 6.25 | 6.25 | 6.25 | 6.25 | 6.25 | 6.25 |
| | × 10⁻⁴ | × 10⁻⁴ | × 10⁻⁴ | × 10⁻⁴ | × 10⁻⁵ | × 10⁻⁵ | × 10⁻⁵ | × 10⁻⁵ |
| [Al]^{k)} | 1.88 | 1.88 | 1.88 | 1.88 | 1.88 | 1.88 | 1.88 | 1.88 |
| | × 10⁻¹ | × 10⁻¹ | × 10⁻¹ | × 10⁻¹ | × 10⁻² | × 10⁻² | × 10⁻² | × 10⁻² |
| Yield | 600 | 990 | 3390 | 2880 | 330 | 830 | 1270 | 1860 |
| (mg)^{d)} | | | | | | | | |
| Activ.^{e)} | 110 | 480 | 1200 | 460 | 250 | 2400 | 3100 | 1700 |
| M.p. (°C.)^{f)} | 260/ | 263 | 258/ | 243/ | 264 | 261/ | 257/ | 247/ |
| | 267 | | 250 | 250 | | 267 | 265 | 258 |
| M_{W} ^{g)} | 390 | 230 | 115 | 40 | 867 | 378 | 96 | 35 |
| Mₙ ^{h)} | 110 | 107 | 44 | 17 | 557 | 162 | 53 | 17 |
| M_{W}/Mₙ ⁱ⁾ | 3.56 | 2.15 | 2.60 | 2.47 | 1.56 | 2.34 | 1.82 | 2.09 |

Table 2 below shows the polymerization activities of the catalysts used in Example 2 and Comparative Example 2 and the characteristic data of the polymers obtained in Example 2 and Comparative Example 2.

TABLE 2

| | Comparative Example 2 | | | | Example 2 | | | |
|---|---|---|---|---|---|---|---|---|
| | Cp*TiCl₃^{a)} | | | | Cp*TiF₃^{a)} | | | |
| T(°C.)^{b)} | 10 | 30 | 50 | 70 | 10 | 30 | 50 | 70 |
| t(h)^{c)} | 2.80 | 1.03 | 1.00 | 0.77 | 0.52 | 0.35 | 0.22 | 0.23 |
| [Ti]^{j)} | 6.25 | 6.25 | 6.25 | 6.25 | 6.25 | 6.25 | 6.25 | 6.25 |
| | × 10⁻⁴ | × 10⁻⁴ | × 10⁻⁴ | × 10⁻⁴ | × 10⁻⁵ | × 10⁻⁵ | × 10⁻⁵ | × 10⁻⁵ |
| [Al]^{k)} | 1.88 | 1.88 | 1.88 | 1.88 | 1.88 | 1.88 | 1.88 | 1.88 |
| | × 10⁻¹ | × 10⁻¹ | × 10⁻¹ | × 10⁻¹ | × 10⁻² | × 10⁻² | × 10⁻² | × 10⁻² |
| Yield | 49 | 90 | 385 | 730 | 49 | 240 | 375 | 650 |
| (mg)^{d)} | | | | | | | | |
| Activ.^{e)} | 0.7 | 3.5 | 15.4 | 38 | 38 | 270 | 690 | 1100 |
| M.p. (°C.)^{f)} | 276 | 277 | 275 | 274 | 274 | 275 | 275 | 275 |
| M_{W} ^{g)} | 170 | 189 | 169 | 156 | 966 | 703 | 661 | 511 |
| Mₙ ^{h)} | 62 | 82 | 47 | 43 | 512 | 353 | 367 | 193 |
| M_{W}/Mₙ ⁱ⁾ | 2.75 | 2.31 | 3.63 | 3.61 | 1.89 | 1.99 | 1.80 | 2.64 |

### Example 3

A 200 ml glass reactor heated to 30° C. was charged in a countercurrent of argon while stirring with, in succession, 49 ml of toluene, 0.58 g (0.01 mol) of methylaluminoxane, 50 ml of styrene and 1 ml of a toluene solution of methylcyclopentadienyltitanium trifluoride (10⁻⁵ mol/ml). The addition of the titanium compound was taken as the starting point of the polymerization. After 4 minutes, about 50 ml of a mixture of hydrochloric acid and ethanol were added. Stirring was continued for a further 12 hours. The solid product was filtered off and washed with ethanol until neutral. The polymer was dried under reduced pressure at room temperature.

### Comparative Example 3

Comparative Example 3 was carried out as described in Example 3, but using methylcyclopentadienyltitanium trichloride as catalyst.

Table 3 below shows the polymerization activities of the catalysts used in Example 3 and Comparative Example 3 and the characteristic data of the polymers obtained in Example 3 and Comparative Example 3.

TABLE 3

| | Comparative Example 3 | Example 3 |
|---|---|---|
| | MeCpTiCl₃^{a)} | MeCpTiF₃^{a)} |
| T(° C.)^{b)} | 30 | 30 |
| t (min)^{c)} | 60 | 4 |
| [Ti]^{j)} | 5 × 10⁻⁵ | 5 × 10⁻⁵ |
| [Al]^{k)} | 0.05 | 0.05 |
| Yield | 494 | 482 |
| (mg)^{d)} | | |
| Activ.^{e)} | 99 | 1160 |
| M.p. | 257 | 256 |
| (° C.)^{f)} | | |
| M_{W}^{g)} | 261 | 304 |
| Mₙ^{h)} | 125 | 134 |
| M_{W}/Mₙⁱ⁾ | 2.09 | 2.27 |

### Example 4 and Comparative Example 4

Example 4 was carried out as described in Example 3, but using EtMe₄CpTiF₃ as catalyst. Comparative Example 4 was carried out as described in Example 3, but using EtMe₄CpTiCl₃ as catalyst.

Table 4 below shows the polymerization activities of the catalysts used in Example 4 and Comparative Example 4 and the characteristic data of the polymers obtained in Example 4 and Comparative Example 4.

TABLE 4

| | Comparative Example 4 | Example 4 |
|---|---|---|
| | EtMe₄CpTiCl₃^{a)} | EtMe₄CpTiF₃a) |
| T(° C.)^{b)} | 30 | 30 |
| t(min)^{c)} | 120 | 10 |
| [Ti]^{j)} | 5 × 10⁻⁵ | 5 × 10⁻⁵ |
| [Al]^{k)} | 0.05 | 0.05 |
| Yield | 110 | 140 |
| (mg)^{d)} | | |
| Activ.^{e)} | 11 | 167 |
| M.p. | 277 | 270 |
| (° C.)^{f)} | | |
| M_{W}^{g)} | 193 | 768 |
| Mₙ^{h)} | 94 | 395 |
| M_{W}/Mₙⁱ⁾ | 2.06 | 1.94 |

### Example 5 and Comparative Example 5

Example 5 was carried out as described in Example 3, but using PrMe₄CpTiF₃ as catalyst. Comparative Example 5 was carried out as described in Example 3, but using PrMe₄CpTiCl₃ as catalyst.

Table 5 below shows the polymerization activities of the catalysts used in Example 5 and Comparative Example 5 and the characteristic data of the polymers obtained in Example 5 and Comparative Example 5.

TABLE 5

| | Comparative Example 5 | Example 5 |
|---|---|---|
| | PrMe₄CpTiCl₃^{a)} | PrMe₄CpTiF₃^{a)} |
| T(° C.)^{b)} | 30 | 30 |
| t (min)^{c)} | 120 | 10 |
| [Ti]^{j)} | 5 × 10⁻⁵ | 5 × 10⁻⁵ |
| [Al]^{k)} | 0.05 | 0.05 |
| Yield | 103 | 140 |
| (mg)^{d)} | | |
| Activ.^{e)} | 10 | 167 |
| M.p. | 275 | 271 |
| (° C.)^{f)} | | |
| M_{W}^{g)} | 153 | 636 |
| Mₙ^{h)} | 75 | 304 |
| M_{W}/Mₙⁱ⁾ | 2.05 | 2.09 |

### Example 6 and Comparative Example 6

Example 6 was carried out as described in Example 3, but using BuMe₄CpTiF₃ as catalyst. Comparative Example 6 was carried out as described in Example 3, but using BuMe₄CpTiCl₃ as catalyst.

Table 6 below shows the polymerization activities of the catalysts used in Example 6 and Comparative Example 6 and the characteristic data of the polymers obtained in Example 6 and Comparative Example 6.

TABLE 6

| | Comparative Example 6 | Example 6 |
|---|---|---|
| | BuMe₄CpTiCl₃^{a)} | BuMe₄CpTiF₃^{a)} |
| T (° C.)^{b)} | 30 | 30 |
| t (min)^{c)} | 120 | |
| [Ti]^{j)} | 5 × 10⁻⁵ | 5 × 10⁻⁵ |
| [Al]^{k)} | 0.05 | |
| Yield | 121 | |
| (mg)^{d)} | | |
| Activ.^{e)} | 12 | 185 |
| M.p. | 276 | 273 |
| (° C.)^{f)} | | |
| M_{W}^{g)} | 201 | 683 |
| Mₙ^{h)} | 93 | 309 |
| M_{W}/Mₙⁱ⁾ | 2.16 | 2.21 |

### Examples 7, 8 and 9

Examples 7, 8 and 9 were carried out as described in Example 3, but using Cp*₂TiF, Cp*TiF₂(OCOC₆F₅) and Cp*TiF₂(OCOCF₃) as catalysts.

Table 7 below shows the polymerization activities of the catalysts used in Examples 7, 8 and 9 and the characteristic data of the polymers obtained.

TABLE 7

| | Example 7 | Example 8 | Example 9 |
|---|---|---|---|
| | Cp*₂TiF^{a)} | Cp*TiF₂(OCOC₆F₅)^{a)} | Cp*TiF₂(OCOCF₃)^{a)} |
| T (° C.)^{b)} | 30 | 30 | 30 |
| t (min)^{c)} | 60 | 8 | 10 |
| [Ti]^{j)} | 5 × 10⁻⁵ | 10⁻⁴ | 10⁻⁴ |
| [Al]^{k)} | 0.05 | 0.1 | 0.1 |
| Yield | 174 | 678 | 381 |
| (mg)^{d)} | | | |
| Activ.^{e)} | 35 | 510 | 229 |
| M.p. (° C.)^{f)} | 270 | 269 | 269 |
| M_{W}^{g)} | 612 | 543 | 558 |
| Mₙ^{h)} | 250 | 249 | 261 |
| M_{W}/Mₙⁱ⁾ | 2.45 | 2.18 | 2.14 |

^{a)}Cp = cyclopentadienyl, Cp* = pentamethylcyclopentadienyl, Me = methyl, Et = ethyl, Pr = propyl and Bu = butyl
^{b)}polymerization temperature
^{c)}polymerization time
^{d)}yield of syndiotactic polystyrene
^{e)}polymerization activity of the catalyst system as yield of syndiotactic polystyrene (sPS) in kg based on the molar amount of titanium compound in mol and based on the polymerization time in h: (kg sPS/mol Ti × h)
^{f)}melting point(s) of the polystyrene from the 2nd heating curve of the DSC (differential scanning calorimetry)
^{g)}weight average molecular weight of the polystyrene divided by 1000, determined by GPC (gel permeation chromatography)
^{h)}number average molecular weight of the polystyrene divided by 1000, determined by GPC (gel permeation chromatography)
ⁱ⁾polydispersity of the polystyrene, determined by GPC (gel permeation chromatography)
^{j)}concentration of the titanium compound in mol/l
^{k)}concentration of methylaluminoxane in mol/l

We claim:

1. A catalyst component for the polymerization of olefins, comprising at least one compound of the formula (I):
R^{a}ₙM¹R^{b}ₘ (I),
where
M¹=Ti, Zr or Hf,
R^{a}=C₅ (R¹, R², R³, R⁴, R⁵) or C₆ (R₁, R², R³, R⁴, R⁵, R⁶), where R¹, R², R³, R⁴, R⁵ and R⁶ are identical or different and are each a hydrogen atom, a C₁-C₂₀-alkyl group, a C₁-C₁₀-alkoxy group, a C₁-C₁₀-fluoroalkyl group, a C₆-C₂₀-aryl group, a C₆-C₁₀-aryloxy group, a C₂-C₁₀-alkenyl group, a C₆-C₁₀-fluoroaryl group, a C₇-C₄₀-arylalkyl group, a C₇-C₄₀-alkylaryl group, a C₈-C₄₀-arylalkenyl group, a silyl group or a germyl group or adjacent radicals R₁, R², R³, R⁴, R⁵ and R⁶ together with the atoms connecting them form a ring system,
R^{b}=a fluorine atom when m=1, at least one fluorine atom when m>1 and can be identical or different and can be at least one hydrogen atom, a C₁-C₂₀-alkyl group, a C₁-C₁₀-alkoxy group, a C₁-C₁₀-fluoroalkyl group, a C₆-C₂₀-aryl group, a C₆-C₁₀-aryloxy group, a C₂-C₁₀-alkenyl group, a C₆-C₁₀-fluoroaryl group, a C₇-C₄₀-arylalkyl group, a C₇-C₄₀-alkylaryl group, a C₈-C₄₀-arylalkenyl group, an OH group, an NR⁷₂ or SR⁸₁ group, where R⁷ and R⁸ are each a C₁-C₂₀-alkyl group, a C₁-C₁₀-alkoxy group, a C₁-C₁₀-fluoroalkyl group, a C₆-C₂₀-aryl group, a C₆-C₁₀-aryloxy group, a C₂-C₁₀-alkenyl group, a C₆-C₁₀-fluoroaryl group, a C₇-C₄₀-arylalkyl group, a C₇-C₄₀-alkylaryl group, a C₈-C₄₀-arylalkenyl group, a silyl group, a germyl group, a halogen atom, an —OC(O)F group, an —OC(O)CR^{c}₃ group, an —OC(O)C₅R^{d}₄ group or an —OC(O)C₆R^{e}₅ group, where R^{c}, R^{d} and R^{e} are at least one fluorine atom and R^{c}, R^{d} and R^{e} can be identical or different and be at least one hydrogen atom, a C₁-C₂₀-alkyl group, a C₁-C₁₀-alkoxy group, a C₁-C₁₀-fluoroalkyl group, a C₆-C₂₀-aryl group, a C₆-C₁₀-aryloxy group, a C₂-C₁₀-alkenyl group, a C₆-C₁₀-fluoroaryl group, a C₇-C₄₀-arylalkyl group, a C₇-C₄₀-alkylaryl group, a C₈-C₄₀-arylalkenyl group, an OH group, an NR⁷₂ or SR⁸ group, a silyl group, a germyl group or a halogen atom,
m and n are integers, m+n=2-4 and m is at least 1.

2. A catalyst component as claimed in claim 1, comprising at least one bridge R⁹ between at least two radicals R^{a}, R⁹ is preferably 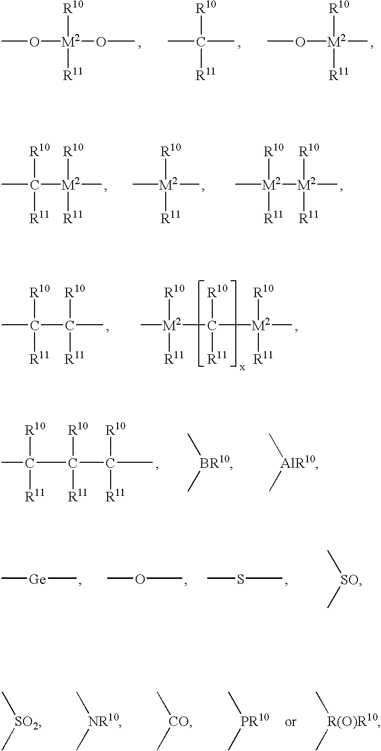
where R¹⁰ and R¹¹ are identical or different and are each a hydrogen atom, a halogen atom or a C₁-C₄₀-group such as a C₁-C₂₀-alkyl group, a C₁-C₁₀-fluoroalkyl group, a C₁-C₁₀-alkoxy group, a C₆-C₁₄-aryl group, a C₆-C₁₀-fluoroaryl group, a C₆-C₁₀-aryloxy group, a C₂-C₁₀-alkenyl group, a C₇-C₄₀-arylalkyl group, a C₇-C₄₀-alkylaryl group or a C₈-C₄₀-arylalkenyl group or R¹⁰ and R¹¹, in each case together with the atoms connecting them, form one or more rings, and x is an integer from zero to 18,
M² is silicon, germanium or tin,
R⁹ can also link two units of the formula (I) to one another.

3. A catalyst system comprising at least one catalyst component and at least one organic boron compound and/or at least one organic aluminum compound and/or at least one organic tin compound.

4. A catalyst system as claimed in claim 3, obtainable by bringing at least one catalyst component into contact with at least one organic boron compound and/or at least one organic aluminum compound and/or at least one organic tin compound.

5. A catalyst system as claimed in claim 3 or 4, comprising at least one inorganic and/or organic support.

6. A polymer and/or copolymer obtainable by polymerization using a catalyst system as claimed in any of claims 3 to 5.

7. A polymer and/or copolymer of 1-alkenes and vinylaromatics, obtainable by polymerization using a catalyst system as claimed in any of claims 3 to 5.

8. A syndiotactic polymer obtainable by polymerization using a catalyst system as claimed in any of claims 3 to 5.

9. A syndiotactic polystyrene obtainable by polymerization using a catalyst system as claimed in any of claims 3 to 5.

10. A process for polymerization and/or copolymerization using a catalyst system as claimed in any of claims 3 to 5.

11. A process as claimed in claim 10 for polymerization and/or copolymerization of 1-alkenes and vinylaromatics.

12. A process as claimed in claim 10 or 11 for the polymerization of styrene to syndiotactic polystyrene.

13. The use of a catalyst system for preparing a polymer and/or copolymer, particularly for the polymerization and/or copolymerization of 1-alkenes and vinylaromatics, very particularly for the polymerization of styrene.
